(19) United States
(12) Patent Application Publication
(10) Pub. No.: US 2012/0110451 A1
(43) Pub. Date: May 3, 2012

(54) PROVIDING HELP INFORMATION

(75) Inventors: Xiang Yang He, Beijing (CN); Shun Jiang, Beijing (CN); Tie Liu, Beijing (CN); Hao Zhang, Beijing (CN)

(73) Assignee: INTERNATIONAL BUSINESS MACHINES CORPORATION, Armonk, NY (US)

(21) Appl. No.: 13/272,354

(22) Filed: Oct. 13, 2011

(30) Foreign Application Priority Data
Oct. 29, 2010 (CN) 201010532254.X

(51) Int. Cl. G06F 3/01

(52) U.S. Cl. 715/709

(57) ABSTRACT

A method of providing help information for an application program includes capturing, with a computing device, an operation performed for completing a task; recording the operation in correspondence to the task; and indicating the operation in an application program interface for a user to perform the same operation in response to the user's designation of the task.

### PRIORITY

This application claims priority to Chinese Patent Application No. 201010532254.X, filed 29 Oct. 2010, and all the benefits accruing therefrom under 35 U.S.C. §119, the contents of which in its entirety are herein incorporated by reference.

### BACKGROUND

The invention relates to the field of data processing, and more particularly, to a method and apparatus of providing help information.

Application programs provide various functions for computer users. In order to help the user, most application programs provide help information so as to enable the user to solve common problems by looking up the help information when the common problem is encountered. If multiple operations are needed for the user to complete a task, a common approach is to enumerate these operations. FIG. 1 illustrates a set of exemplary help instructions provided by an application program. In this example, 4 operations for completing the task “look up the archive standard of the database” are enumerated, wherein the user can look up the archive standard of the database by operating in accordance with these 4 operations.

The method shown in FIG. 1 assumes that the user has certain knowledge about the application. For example, it is assumed that user actually knows how to open a database, where to select “file-database-attribute,” etc. However, for a user with no relevant experience, these assumptions are not always true. A user may not know how to open a database and where to select an operation at all. As an approach to this problem, a screen recording tool may be used to record the operation for completing the task. However, regardless of whether the required operations are enumerated by text or the required operations are played via video, there is a need for the user to repeatedly switch between the help interface and the application program interface.

### SUMMARY

In one embodiment, a method of providing help information for an application program includes capturing, with a computing device, an operation performed for completing a task; recording the operation in correspondence to the task; and indicating the operation in an application program interface for a user to perform the same operation in response to the user's designation of the task.

In another embodiment, an apparatus for providing help information for an application program includes capturing means configured to capture an operation performed for completing a task; recording means configured to record the operation in correspondence to the task; and indicating means configured to indicate the operation in an application program interface for a user to perform the same operation in response to the user's designation of the task.

In another embodiment, a non-transitory, computer readable medium having computer readable instructions stored thereon that, when executed by a computer, implement a method of providing help information for an application program. The method includes capturing, with a computing device, an operation performed for completing a task; recording the operation in correspondence to the task; and indicating the operation in an application program interface for a user to perform the same operation in response to the user's designation of the task.

### BRIEF DESCRIPTION OF SEVERAL VIEWS OF THE DRAWINGS

FIG. 1 illustrates a set of exemplary help instructions provided by an application program.

FIG. 2 is a flow diagram illustrating a method of providing help information according to an embodiment of the invention.

FIG. 3 illustrates an application program interface when a task creator is using an exemplary application program.

FIGS. 4A-4C illustrate application program interfaces when providing help information to a user.

FIGS. 5A-5S illustrate application program interfaces when providing help information to a user.

FIG. 6 is a block diagram illustrating an apparatus of providing help information according to an embodiment of the invention.

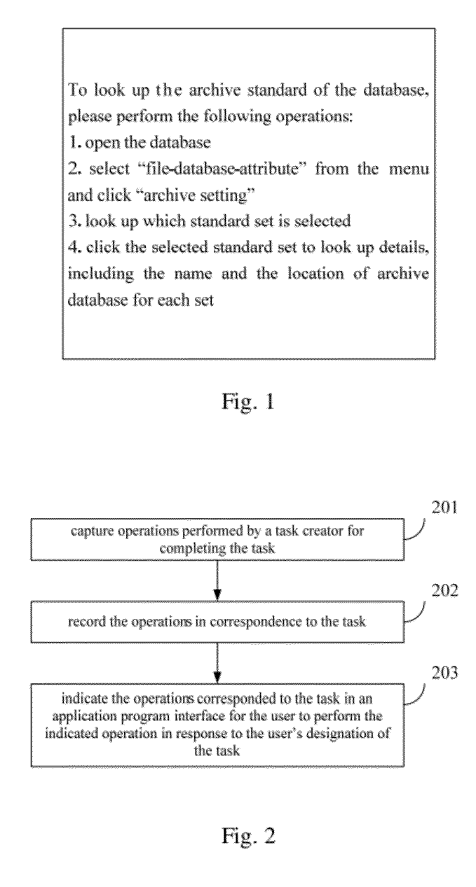

### DETAILED DESCRIPTION

According to a technical solution of embodiments of the invention, help information can be provided more efficiently to the user, especially to one that is totally unfamiliar with an application program, and it can prevent the user from repeatedly switching between an application program interface and a help interface.

Detailed embodiments of an apparatus and method for providing help information are described below with reference to drawings. Hereinafter, many specific details are explained so as to understand the invention thoroughly. However, those skilled in the art can appreciate that, the implementation of the invention may not have some of the specific details, and the invention is not limited to the described specific embodiments. Rather, it may be considered to use any combination of the below features and elements to implement the invention regardless of whether they relate to different embodiments. Thus, the aspects, features, embodiments and advantages below are merely illustrative and should not be construed as elements or definitions of the appended claims, unless otherwise explicitly specified in claims. It should also be noted that, in order to avoid obscuring the invention with unnecessary details, only means structures and/or processing steps that are closely associated with the solution of the invention are illustrated in the drawings, and other details that have little relationship therewith are omitted. Further, except where “direct” or “indirect” are intentionally used to define, connections described include both direct and indirect connection.

Reference is initially made to FIG. 2 which depicts a method of providing help information for an application program according to an embodiment of the invention. As shown in block 201, operations performed by a task creator for completing a task are captured.

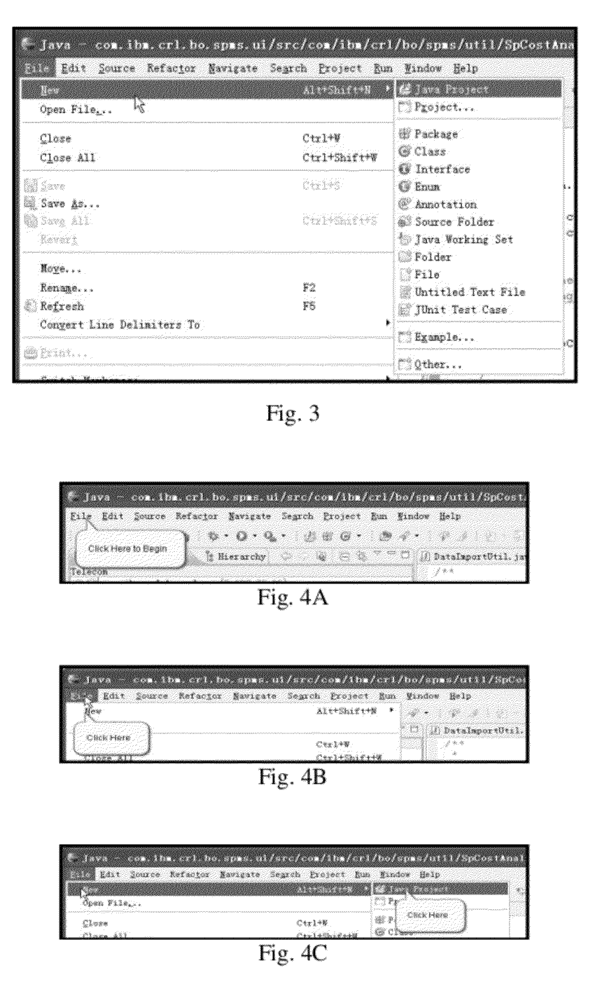

Referring now to FIG. 3, an exemplary screen shot illustrates a part of operations performed for completing the task “create a new project” when the task creator is using an exemplary application program. As shown in FIG. 3, the task creator first opens the “File” menu, selects the “New” menu item, then selects the “Java Project” menu item in the popped-up menu.

Those skilled in the art can appreciate that respective components of windows-type application programs, including menus, menu items, sub-menus, controls such as input boxes that can get focus, sliding bars, and drop-down lists etc., may all be regarded as an object. Each object has a corresponding object ID. The operating system often provides visual operation indicator, such as an arrow cursor, to help the task creator to select an object on an application program interface. The task creator may move the arrow cursor with an input device such as a mouse, and select a certain object by overlapping the location of the arrow cursor on the application program interface with the object on the application program interface. Further, the input made by the task creator, such as moving the mouse, clicking the left button of mouse, clicking the right button of mouse, tapping certain keys on the keyboard, etc., all correspond to an input event, which can be captured by the operating system running the application program. Thus, the operation performed by the task creator on the application program interface can often be expressed in two parts: a certain object selected in the application program interface; and a certain input event performed by the task creator on the object. Herein, the certain object selected in the application program interface may be determined by the location of the operator indicator in the application program interface when the task creator performs the input event. Those skilled in the art can appreciate that the so-called application program interface refers to the current interface of the application program. An application program may have a plurality of interfaces overlapped with each other; however, one of them can always be designated as a current interface.

Taking operations performed in FIG. 2 for example, the operation in which the task creator opens the “File” menu may be expressed as: the location of the operation indicator in the application program interface is the “File” object in the application program interface; the task creator performs an input operation of clicking the left button of the mouse. Here, characters shown on the object are used as the object ID. Those skilled in the art can determine the ID of an object in any other suitable manner. Similarly, the operation in which the task creator selects the “New” menu item may be expressed as: the location of the operation indicator in application program interface is the “New” object in the application program interface; the task creator performs an operation of clicking the left button of the mouse. The operation in which the task creator selects the “Java Project” menu item in the popped-up menu may be expressed as: the location of the operation indicator in the application program interface is the “Java Project” object in the application program interface; the task creator performs an operation of clicking the left button of the mouse.

Referring once again to FIG. 2, in block 202, the operations are recorded in correspondence to the task.

As described above, a series of operations performed by the task creator may be captured, and the series of operations correspond to a specific task, such as “create a new project”. Thus, the operations may be recorded in correspondence to the task in various manners, where an example of these manners is as follows:

task name = create a new project;
operation 1: object = “File” object, input event = click the left button of
the mouse;
operation 2: object = “New” object, input event = click the left button of
the mouse;
operation 3: object = “Java Project” object, input event = click the left
button of the mouse;
operation 4: ......;
......
Operation n: ......

In actual implementation, the above records are made in a manner that can be understood by a computer system.

Further, description of the operation may be provided by the task creator. The description may be characters that the task creator believes to describe the input event more clearly. For example, in some cases, the operations corresponding to the task that have been described by the task creator may be recorded as:

task name = create a new project;
operation 1: object = “File” object, input event = click the left button of
the mouse, description = Click Here to Begin;
operation 2: object = “New” object, input event = click the left button of
the mouse, description = Click Here;
operation 3: object = “Java Project” object, input event = click the
left button of the mouse, description = Click Here;
operation 4: ......;
......
Operation n: ......

Furthermore, the task creator may make some incorrect operations while creating a task, thus an interface may be further provided for the task creator to delete some recorded operations.

In block 203 of FIG. 2, the operations corresponding to the task are indicated in the application program interface for the user to perform the indicated operation in response to user's designation of the task.

The user may designate one of the recorded tasks when using an application program and where the user needs help information. The application program may provide a list of common tasks, and presents the list to the user in response to some operations of user, such as pressing the “F1” key, such that user may select and designate a task from the list.

In response to the user's designation of one task, the recorded operations are indicated one by one in the application program interface. Since each operation actually includes two parts, i.e., the object on the application program interface and the input event, the operation may be indicated by highlighting the object on the application program interface and prompting user to perform the input event.

Still using the above three operations for example, it is assumed that the task creator has provided descriptions for the respective steps and, in the case that the task creator has provided descriptions for steps, that the descriptions made by the task creator are used as the prompting information while prompting the input event. Diagrams of providing help information to the user are shown in FIG. 4A, FIG. 4B and FIG. 4C. For operation 1, as shown in FIG. 4A, the “File” object on the application program interface is highlighted with a balloon, which displays the prompting information “Click Here to Begin.” The highlight may also be performed by means of an arrow, translucent label, coloring, and the like. The prompt may be displayed in conjunction with a highlight, and may also be displayed in any suitable place. Similarly, for operation 2, as shown in FIG. 4B, the “New” object on the application program interface is highlighted with a balloon, which displays the prompting information “Click Here.” For operation 3, as shown in FIG. 4C, the “Java Project” object on the application program interface is highlighted with a balloon, which also displays the prompting information “Click Here.”

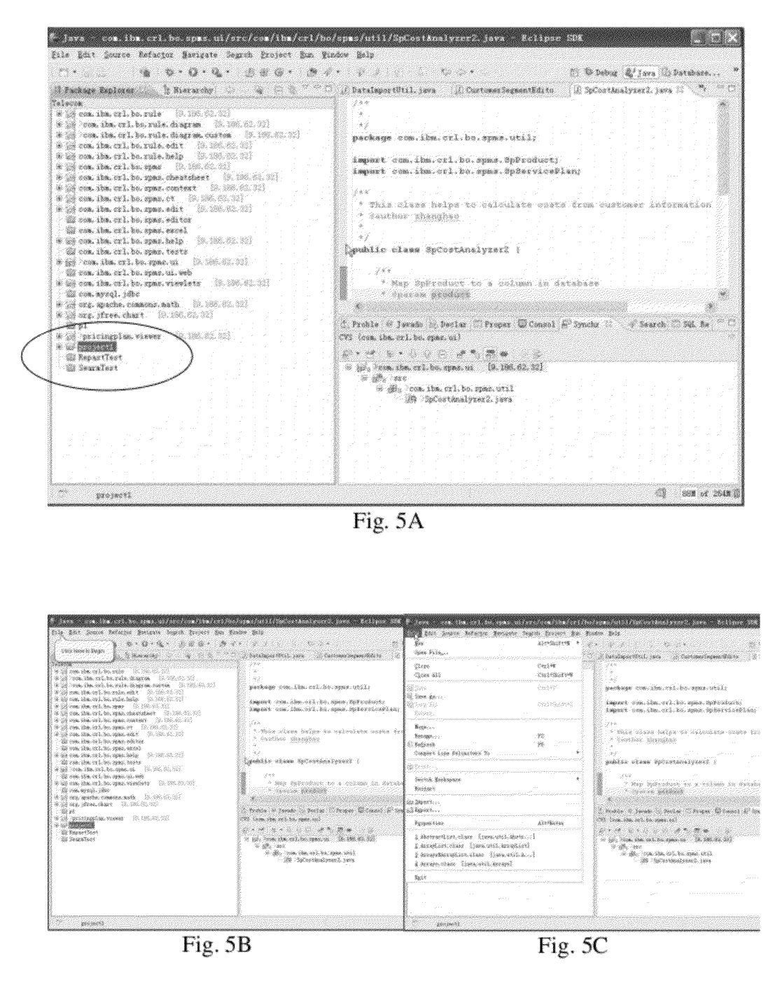

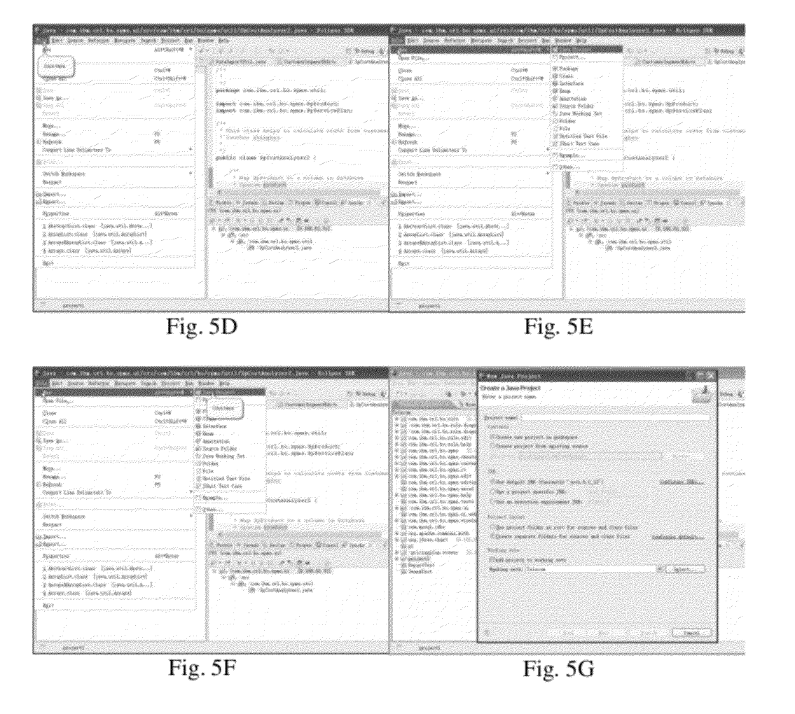

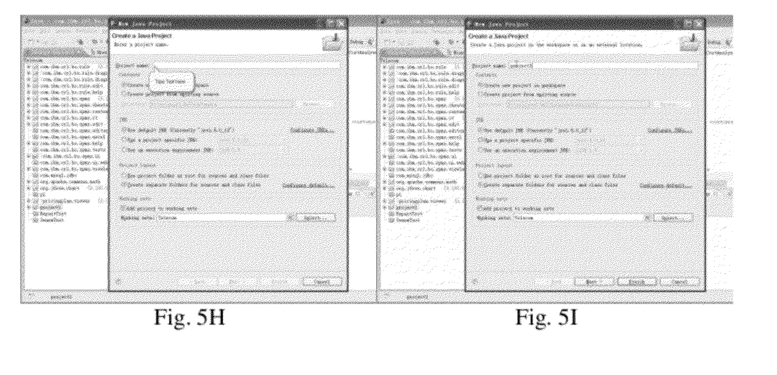

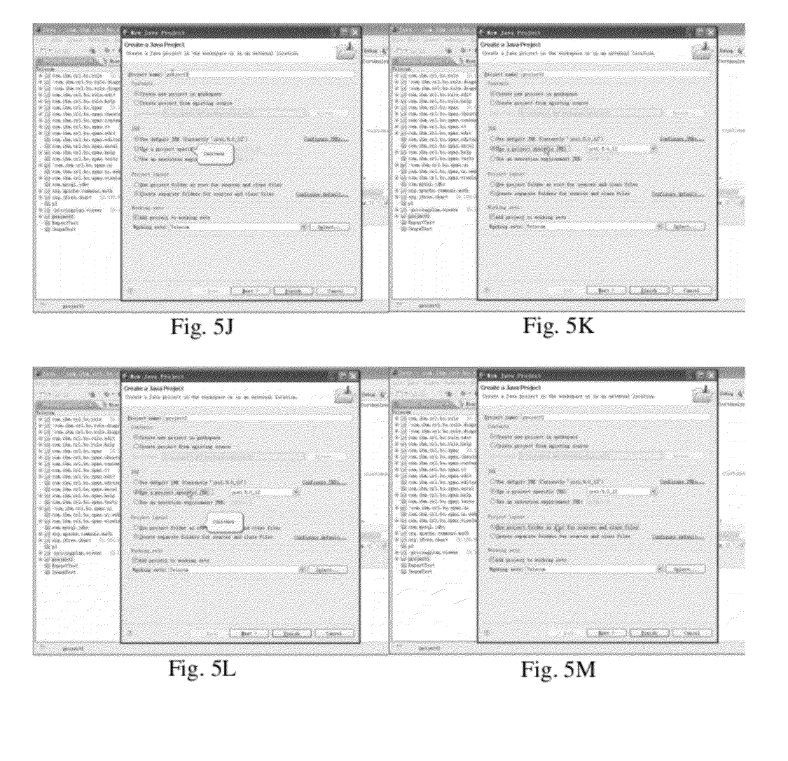

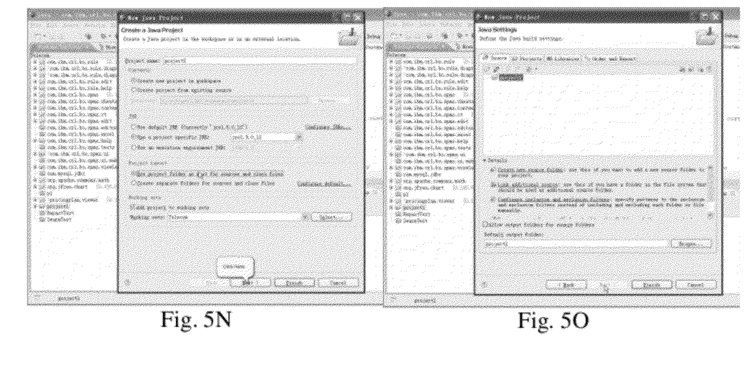

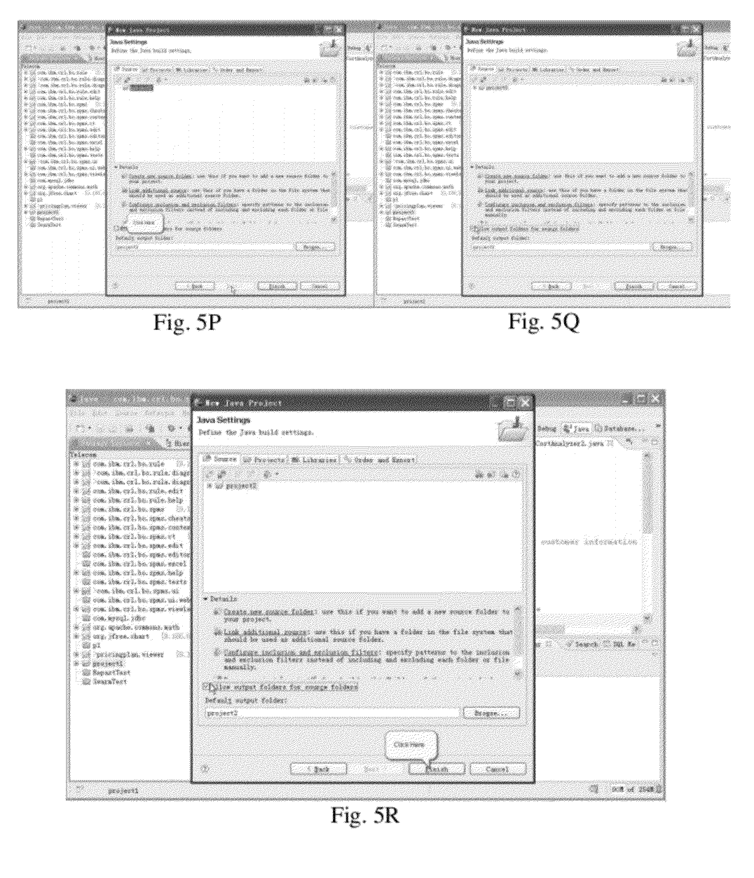

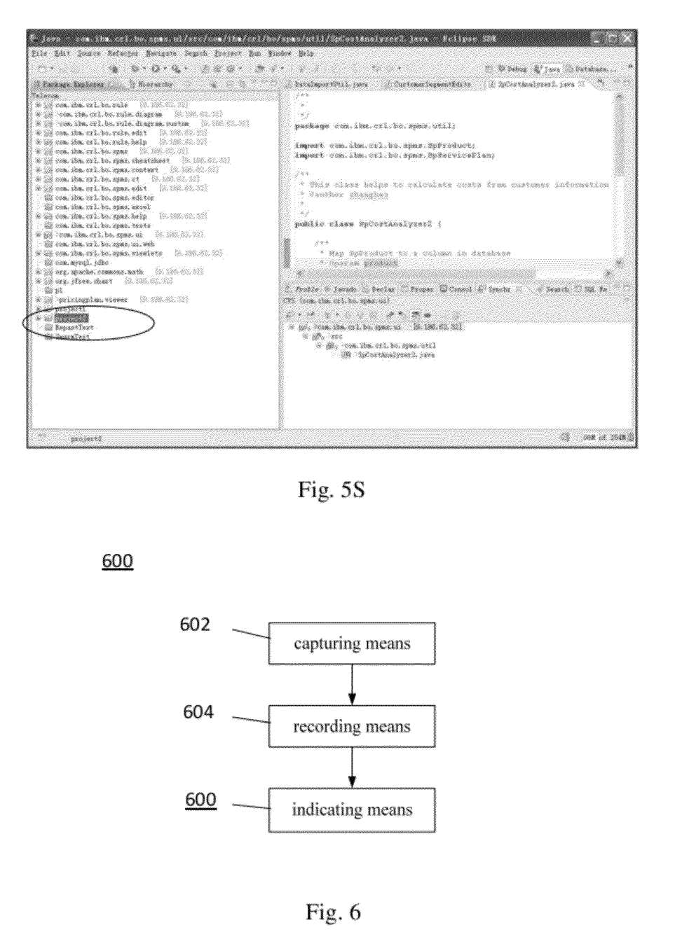

FIG. 5A-FIG. 5S illustrate application program interfaces in providing help information corresponding to “create a new project” to the user according to an embodiment of the invention. FIG. 5A, with the exception of the ellipse block, is a diagram of the application program interface before it starts to provide help information. It will be noted that, within the ellipse block, there is shown a project entitled “project1.” FIGS. 5B, 5D, 5F, 5H, 5J, 5L, 5N, 5P are the application program interfaces when the operations corresponding to the task indicated, while FIGS. 5C, 5E, 5G, 5I, 5K, 5M, 50, 5Q are the application program interfaces obtained after the user actually performs the operations. In FIG. 5R, the user is prompted to click the “Finish” object to complete the task of “create a new project”. After the user clicks the object, the application program interface is shown as the part in FIG. 5S with the exception of the ellipse block. It can be seen that, within the ellipse block, there is another project labeled “project2” in addition to the existing project “project1.”

Reference is now made to FIGS. 5H-5L. In FIG. 5I, the user enters “project2” in an input box in accordance with the prompt in FIG. 5H. However, the application program may not know that the user has finished entering the project name, and thus not know when to indicate the next operation. One solution is to allow the user to denote of the completion of entering the project with another input event such as pressing the enter key on the keyboard. Thus, the operation indicated in FIG. 5H actually corresponds to at least two parts of input event: one part of the input event is to press character keys on the keyboard by the user, such as the letter key and the numeral key; the other part of the input event is to press the enter key on the keyboard by the user. Another solution may be, after a predefined interval following the indication as shown in FIG. 5H, to further indicate a next operation as shown in FIG. 5J. If the user performs the next operation as shown in FIG. 5K, it means that user has finished entering, such that the indication can be continued as shown in FIG. 5L.

FIG. 6 is a block diagram an apparatus 600 of providing help information for an application program according to an embodiment of the invention. As is shown, the apparatus includes capturing means 602 configured to capture operation performed by a task creator for completing the task, recording means 604 configured to record the operation in correspondence to the task, and indicating means 606 configured to indicate the operation corresponded to the task in an application program interface for user to perform the indicated operation in response to user's designation of the task.

Further, the recording means may include means configured to receive description of the operation provided by the task creator. The indicating means includes means configured to display the description in correspondence to the operation.

The recording means may further include means configured to provide an interface for the task creator to delete the recorded operation.

Those skilled in the art can appreciate that, the above method and system may be implemented by computer executable instructions and/or control codes contained in a processor, for example, such codes are provided on carrier medium such as magnetic disk, CD or DVD-ROM, programmable memory such as read-only memory (firmware) or data carrier such as optical or electronic signal carrier. The system of providing help information for an application program of the embodiment and components thereof may be implemented by hardware circuit such as large scale integrated circuit or gate arrays, semiconductors such as logic chip or transistors, or programmable hardware devices such as field programmable gate array, programmable logic device, or can be implemented in form of various processors executing corresponding software, or can be implemented by a combination of the above hardware circuit and software such as firmware.

Although several exemplary embodiments of the invention have been illustrated and described, those skilled in the art will appreciate that changes may be made to these embodiments without departing from the spirit and scope of the invention. The scope of the invention is defined by the appended claims and their equivalent transformations.

What is claimed is:

1. A method of providing help information for an application program, the method comprising:
capturing, with a computing device, an operation performed for completing a task;
recording the operation in correspondence to the task; and
indicating the operation in an application program interface for a user to perform the same operation in response to the user's designation of the task.

2. The method according to claim 1, wherein capturing the operation performed for completing a task comprises:
acquiring a location of an operation indicator in the application program interface in response to an input event;
acquiring an object in the application program interface located at the location; and
treating the input event and the object as the operation correspondingly.

3. The method according to claim 2, wherein indicating the operation in the application program interface comprises:
highlighting the object in the application program interface, and prompting the user to perform the input event.

4. The method according to claim 1, wherein recording the operation in correspondence to the task comprises:
receiving description of the operation;
wherein indicating the operation in the application program interface comprises:
displaying the description in correspondence to the operation.

5. The method according to claim 1, wherein recording the operation in correspondence to the task comprises:
providing an interface to help a task creator to delete the recorded operation.

6. An apparatus for providing help information for an application program, comprising:
capturing means configured to capture an operation performed for completing a task;
recording means configured to record the operation in correspondence to the task; and
indicating means configured to indicate the operation in an application program interface for a user to perform the same operation in response to the user's designation of the task.

7. The apparatus according to claim 6, wherein the capturing means comprises:
means configured to acquire a location of an operation indicator in the application program interface in response to an input event;
means configured to acquire an object in the application program interface located at the location; and
means configured to treat the input event and the object as the operation correspondingly.

8. The apparatus according to claim 7, wherein the indicating means comprises:
means configured to highlight the object in the application program interface and prompt the user to perform the input event.

9. The apparatus according to claim 6, wherein the recording means comprises:
means configured to receive description of the operation;
wherein the indicating means comprises:
means configured to display the description in correspondence to the operation.

10. The apparatus according to claim 6, wherein the recording means comprises:
means configured to provide an interface to help a task creator to delete the recorded operation.

11. A non-transitory, computer readable medium having computer readable instructions stored thereon that, when executed by a computer, implement a method of providing help information for an application program, the method comprising:
capturing, with a computing device, an operation performed for completing a task;
recording the operation in correspondence to the task; and
indicating the operation in an application program interface for a user to perform the same operation in response to the user's designation of the task.

12. The computer readable medium according to claim 11, wherein capturing the operation performed for completing a task comprises:
acquiring a location of an operation indicator in the application program interface in response to an input event;
acquiring an object in the application program interface located at the location; and
treating the input event and the object as the operation correspondingly.

13. The computer readable medium according to claim 12, wherein indicating the operation in the application program interface comprises:
highlighting the object in the application program interface, and prompting the user to perform the input event.

14. The computer readable medium according to claim 11, wherein recording the operation in correspondence to the task comprises:
receiving description of the operation;
wherein indicating the operation in the application program interface comprises:
displaying the description in correspondence to the operation.

15. The computer readable medium according to claim 11, wherein recording the operation in correspondence to the task comprises:
providing an interface to help a task creator to delete the recorded operation.
